(19) United States
(12) Patent Application Publication
(10) Pub. No.: US 2015/0058826 A1
(43) Pub. Date: Feb. 26, 2015

(54) SYSTEMS AND METHODS FOR EFFICIENTLY AND EFFECTIVELY DETECTING MOBILE APP BUGS

(71) Applicant: The Trustees of Columbia University in the City of New York, New York, NY (US)

(72) Inventors: GANG HU, New York, NY (US); Yang Tang, New York, NY (US); Xinhao Yuan, New York, NY (US); Junfeng Yang, New York, NY (US)

(73) Assignee: The Trustees of Columbia University in the City of New York, New York, NY (US)

(21) Appl. No.: 14/468,020

(22) Filed: Aug. 25, 2014

Related U.S. Application Data
(60) Provisional application No. 61/870,036, filed on Aug. 26, 2013.
(60) Provisional application No. 61/903,166, filed on Nov. 12, 2013.
(60) Provisional application No. 61/972,080, filed on Mar. 28, 2014.

(51) Int. Cl. G06F 11/36; G06F 9/54

(52) U.S. Cl. CPC G06F 11/3636; G06F 11/362; G06F 11/3664; G06F 11/3668; G06F 9/542
USPC 717/128

(57) ABSTRACT

The disclosed subject matter provides techniques for detecting and diagnosing mobile app bugs. An approximate execution mode screens for potential bugs, which can expose bugs but can generate false positives. From the generated bug reports, certain bugs can be automatically validated and false positives pruned, reducing the need for manual inspection.

### CROSS REFERENCE TO RELATED APPLICATIONS

This application claims priority from provisional application No. 61/870,036 filed Aug. 26, 2013, provisional application No. 61/903,186 filed Nov. 12, 2013, and provisional application No. 61/972,080 filed Mar. 28, 2014, which are incorporated by reference herein.

### STATEMENT REGARDING FEDERALLY SPONSORED RESEARCH

This invention was made with government support under contract number CNS-0905246 awarded by the National Science Foundation. The government has certain rights in the invention.

### BACKGROUND

Mobile applications, or “apps,” can be an important part of mobile device ecosystems. They can help users check e-mail, search the web, social-network, process documents, edit pictures, access data, etc. Google Play, the app store of Android, has over one million apps with tens of billions of downloads at the time of this writing.

Unfortunately, apps can have bugs that offset their convenience and usability. One reason for bugs in apps is that they often must correctly handle a vast variety of system and user actions. For instance, an app can be switched to the background, and then time out (or be terminated) by the mobile operating system (“OS”), such as Android, at any moment regardless of the state the app is then in. Yet, when the user returns to the app, it can restore its state and proceed as if no interruption had ever occurred. Unlike certain operating systems, which support generic swapping of processes, a mobile OS can terminate apps running in the background to save battery power and memory, while requiring the apps to backup and restore their own states.

App developers thus consider how to handle all system actions that can pause, stop, and kill their app—the so-called lifecycle events in Android—at any moment. In addition to these system actions, users can under certain circumstances trigger arbitrary user interface (“UI”) actions available on the screen. Unexpected user actions can cause various problems, including security exploits that bypass screen locks.

In Android, an app organizes its logic into activities, each representing a single screen user interface. For instance, an e-mail app can have an activity for user login, another for listing e-mails, another for reading an e-mail, and yet another for composing e-mail. The number of activities varies between apps, from a few to a few hundred, depending on an app's functionality. The activities can run in the app's main thread of execution.

An activity can contain widgets through which users can interact with the app. Android provides a standard set of widgets, such as buttons, text boxes, seek bars (a slider for users to select a value from a range of values), switches (for users to select options), and number pickers (for users to select a value from a set of values by touching buttons or swiping on a touch screen). Widgets can handle a standard set of UI actions, such as, for example, clicks (press and release a widget), long-clicks (press, hold, and release a widget), typing text into text boxes, sliding seek bars, and toggling switches.

Users can interact with widgets by triggering low-level events, including touch events (by touching the device's screen) and key events (by pressing or releasing real or virtual keys). The Android OS and certain apps can work together to compose the low-level events into actions and then to dispatch the actions to the correct widgets. The dispatch process can be complex because developers can customize widgets in many different ways. For instance, developers can override the low-level event handlers to compose the events into non-standard actions or forward events to other widgets for handling. Moreover, developers can create a Graphical User Interface (“GUI”) layout with one widget layered on top of another widget, so the widget on top receives the actions.

Users can also interact with an activity through special keys found on Android devices. For example, the Back key can cause Android to go back to the previous activity or undo a previous action. The Menu key can pop up a menu widget listing actions that can be performed within the current activity. The Search key can start a search in the current app.

In addition to user actions, an activity handles a set of systems actions called lifecycle events. With reference to FIG. 1, Android can use these lifecycle events to inform an activity about status changes including, for example, when (1) the activity is created (onCreate 11); (2) the activity becomes visible to the user but can be partially covered by another activity (onStart 12 and onRestart 13); (3) the activity becomes the app running in foreground and therefore receives user actions (onResume 14); (4) the activity is covered by another activity but can still be partially visible (onPause 15); (5) the activity is switched to the background (onStop 16); and (6) the activity is destroyed (onDestroy 17).

Android can dispatch lifecycle events to an activity for certain purposes. For instance, when an activity is first created, it can read data from a file and load those data into widgets. Further, lifecycle events can give an activity a chance to save its state before Android kills it.

User actions, lifecycle events, and their interplay at runtime can be arbitrary and complex. According to evaluation results, many popular apps and even the Android framework can fail to handle them correctly. Accordingly, there is a need for an improved system.

### SUMMARY

The disclosed subject matter provides systems and methods for detecting and diagnosing software bugs in mobile apps. In an example embodiment, a system automatically detects a mobile app's GUI layout and associated event handlers. The app can be tested in an approximate execution mode to screen for potential bugs by invoking the app's event handlers. The approximate execution mode can invoke the mobile app's event handlers serially and without appreciable delay. App failures can be detected and a reporting module can generate a trace of actions leading to the failure. The reporting module can also remove unnecessary and redundant procedures in the trace of actions leading to the app failure.

In certain embodiments, the trace of actions leading the app failure can be re-executed in a faithful execution mode to validate potential bugs. False-positive bug reports that do not lead to app failure in faithful execution mode can be pruned automatically.

In some embodiments, the reporting module can categorize the bugs as reproducible, a false positive, a likely bug, or a likely false positive.

The disclosed subject matter also provides methods of detecting and diagnosing software bugs in mobile apps by executing the app in an approximate execution mode. In an example embodiment, the app is set in an initial state, the actions that can be performed on the app are collected, and method repeatedly selects an action, stores the selection action in an action trace, and performs the selected action by invoked the corresponding action's event handler.

The accompanying drawings, which are incorporated and constitute part of this disclosure, illustrate embodiments of the disclosed subject matter.

### BRIEF DESCRIPTION OF THE DRAWINGS

FIG. 1 shows Android activity lifecycle events.

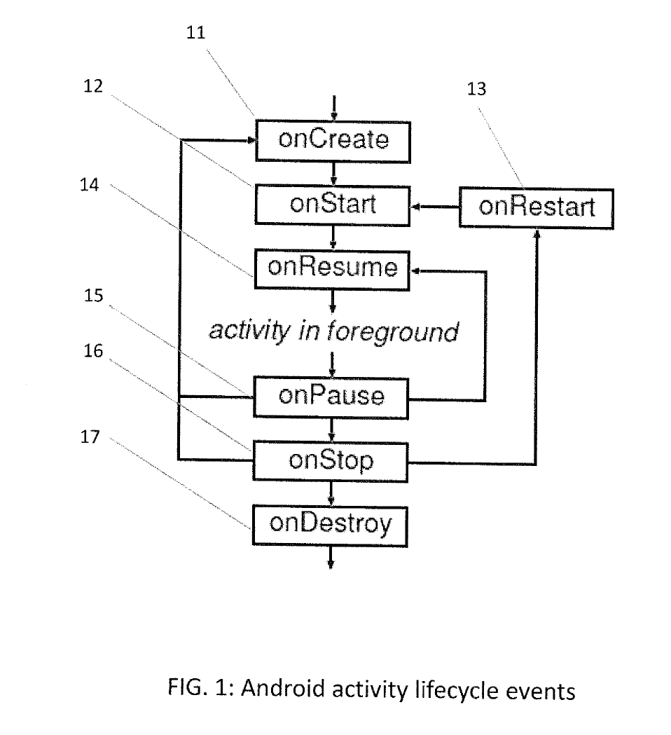

FIG. 2 shows an exemplary workflow of the disclosed subject matter.

FIG. 3 shows an exemplary system architecture of the disclosed subject matter.

FIG. 4 shows the action dependency for verified bugs.

FIG. 5 shows the action dependency for pruned false positives.

Throughout the drawings, the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

Mobile apps can provide convenience, yet they are often buggy, and their bugs undermine their convenience and utility. One reason for buggy apps is that they handle a vast number of unpredictable system and user actions such as being randomly terminated by the operating system to save resources. The disclosed system can help app developers to efficiently and effectively test their apps against many potential system and user actions and interactions, and help diagnose the resultant bug reports. The system can quickly screen for potential bugs using an approximate execution mode that runs much faster than faithful execution and exposes likely bugs, but can cause false positives. From these reports, the system can automatically verify most bugs and prune most false positives, saving manual inspection effort. Action slicing can further speed bug diagnosis.

The disclosed subject matter provides systems and methods for detecting and diagnosing software bugs within mobile apps. In an exemplary embodiment, a system for efficiently and effectively testing apps against many system and user actions, and helping developers diagnose the resulting bug reports, is provided. The disclosed system can use an approximate execution mode to greatly speed up testing and reduce diagnosis effort. The approximate execution mode can screen for potential bugs by performing actions in approximate mode—which can run faster than actions in faithful mode to expose bugs quickly—but allow false positives. For example, instead of waiting for more than two seconds to inject a long-click action into a GUI widget, the disclosed system can simply invoke the widget's long-click event handler.

Directly invoking an event handler can be faster than injecting UI events, but can permit false positives because the processing logic is different. For example, when a UI event is injected, the corresponding event handler is not necessarily invoked at all, because the app's event dispatch logic can ignore the event or forward the event to another widget.

Given a set of bug reports detected through approximate executions, the disclosed subject matter can reduce the false positives caused by approximation as follows. Based on the traces of actions in bug reports, the disclosed subject matter can automatically validate bugs by generating test-cases of low-level events such as key presses and screen touches (e.g., a real long click). These test-cases can be used by developers to reproduce the bugs independently. Moreover, the disclosed subject matter can automatically prune certain false positives with a disclosed algorithm that can selectively switch between approximate and faithful executions.

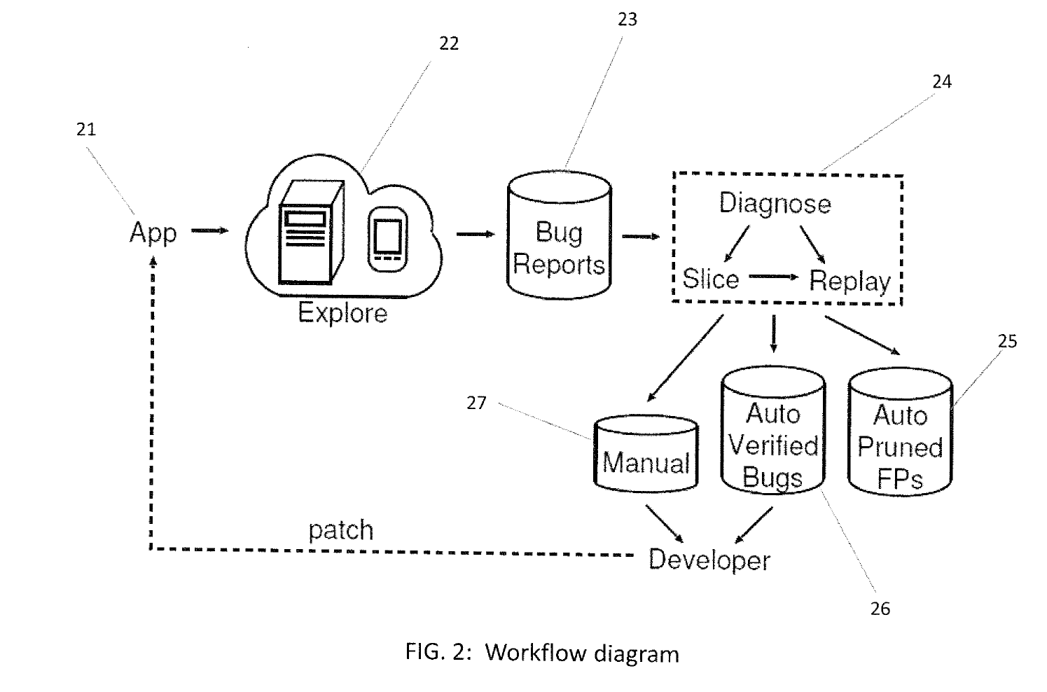

With reference to FIG. 2, given a mobile app 21, the disclosed subject matter can explore potential executions of the app on a cloud of physical devices and emulator instances 22 by repeatedly injecting actions. The exploration can use a variety of search algorithms and heuristics to select the actions to inject. To quickly screen for potential bugs, the disclosed subject matter can perform actions in an approximate mode during exploration. For each potential bug detected, the system can emit a report describing the failure caused by the bug and a trace of actions leading to that failure.

Once the disclosed subject matter collects a set of bug reports 23, it runs an automated diagnosis procedure 24 to classify the reports as bugs and false positives by replaying each trace several times in approximate, faithful, and mixed mode. The system can afford to replay potential bug traces several times because the number of bug reports is much smaller than the number of checked executions. The disclosed system also applies action slicing to reduce the length of bug traces, further simplifying diagnosis. The disclosed subject matter then provides (1) a set of verified bugs 26 accompanied with test-cases that can reproduce the bugs on clean devices independent; (2) a set of auto-pruned false positives 25 that developers do not need to inspect; and (3) a small number of reports marked as likely bugs or false positives with detailed traces for developer inspection 27.

The disclosed system can focus on bugs that can cause crashes. The disclosed subject matter can target apps that use standard widgets and support standard actions. The disclosed subject matter can also automatically generate inputs for the actions it supports (e.g., text in a text box), but cannot necessarily find bugs requiring a specific input (e.g., a specific text string). Approximate execution is essentially a “bloom filter” approach to bug detection that aggressively embraces approximation: it leverages approximation for speed and then validates results with real (i.e., faithful) executions. The disclosed subject matter can generate test-cases to help developers independently reproduce bugs.

Action slicing can be employed to further speed up the reproduction and diagnosis of mobile app bugs. The trace leading to a bug often contains many redundant or unnecessary actions. A long test-ease can cause a bug to be slow to reproduce and make the cause difficult to isolate. Fortunately, many actions in the trace are not relevant to the bug, and can be sliced out of the trace. However, doing so either requires precise action dependencies or is slow. The disclosed subject matter can employ an action dependency definition to quickly and effectively slice out many unnecessary actions. The system can be dynamic (i.e., it runs code) so that it can find many bugs while emitting few or no false positives.

The disclosed system does not necessarily catch all bugs (i.e., it has false negatives). An alternative is static analysis, but a static tool can have difficulties understanding the asynchronous, implicit control flow due to GUI event dispatch. Moreover, a static tool cannot easily generate low-level event test-cases for validating bugs. The disclosed subject matter does not need to use symbolic execution because symbolic execution is typically neither scalable nor designed to catch bugs triggered by GUI event sequences. As a result, the bugs can be different from those found by static analysis or symbolic execution.

One skilled in the art will understand that the disclosed systems and methods can be applied to any mobile operating system, including, for example, and without limitation, Google's Android platform and Apple's iOS platform. The disclosed subject matter can operate in a cloud of mobile devices or emulators to further scale up testing, and supports many device configurations and Android OS versions. To inject actions, it can leverage Android's instrumentation framework, avoiding modifications to the OS and simplifying deployment.

In accordance with an exemplary embodiment of the disclosed subject matter, a mobile app can be submitted to a web-based service for detection and diagnosis of software bugs. For example, a user can navigate to a website by entering an appropriate URL address and can upload the mobile app for testing. The mobile service can be customizable. For example, testing parameters can be submitted by the user.

In accordance with an exemplary embodiment of the disclosed subject matter, the mobile app can be tested. The testing can be based on the testing parameters submitted by the user. Approximate execution (i.e., invoking the app in approximate mode) can be used to quickly debug the code. In accordance with an exemplary embodiment of the disclosed subject matter, a more detailed review of the bug traces can be conducted after approximate execution to identify and remove false positives.

In certain embodiments, the disclosed systems and methods can support a number of predefined actions, e.g., twenty actions, which can be grouped into multiple classes, e.g., three classes. In one example, seven actions in a first class run much faster in approximate mode than in faithful mode. Five actions in a second class run identically in approximate and faithful modes. Eight actions in the last class have only approximate modes.

In the first class, the first four actions are GUI events relating to an app's GUI widgets, and the other three actions are lifecycle events. A general description of each action is provided below, including how the disclosed subject matter performs that action in approximate mode, in faithful mode, and the primary reason for false positives.

LongClick:

A user presses a GUI widget for a time longer than 2 seconds. In approximate mode, the disclosed subject matter invokes the widget's event handler by calling the widget's performLongClick method. In faithful mode, the disclosed subject matter sends the Down touch event to the widget, waits for three seconds, and then sends the Up touch event. The main reason for false positives is that, depending on the event dispatch logic in Android and the app, the touch events are not necessarily sent to the widget so that the LongClick handler of the widget is not invoked in a real execution. A common scenario is that the widget is covered by another widget on the screen, so the widget on top intercepts all events.

SetEditText:

A user sets the text of a TextBox. In approximate mode, the disclosed subject matter directly sets the text by calling the widget's setText method. In faithful mode, the disclosed subject matter sends a series of low-level events to the text box to set text. The disclosed subject matter can send a touch event to set the focus to the text box, Backspace and Delete key events to erase the old text, and other key events to type the text. One reason for false positives is that developers can customize a text box to allow only certain types of text to be set. For instance, the app can validate the text or override the widget's touch event handler to display a list of predefined text strings from a user can select.

SetNumberPicker:

A user sets the value of a number picker. In approximate execution mode, the disclosed subject matter directly sets the value by calling the widget's setValue method. In faithful mode, the disclosed subject matter sends a series of touch events to press the buttons inside the number picker to gradually adjust its value. A reason for false positives is similar to that of SetEditText, where developers can allow only certain values to be set.

ListSelect:

A user scrolls a list widget and selects an item in the list. In approximate execution mode, the disclosed subject matter calls the widget's setSelection method to make the item show up on the screen and select it. In faithful mode, the disclosed subject matter sends a series of touch events to scroll the list until the given item appears. A reason for false positives is that developers can customize the list widget and limit the range of the list visible to a user.

PauseResume:

A user switches an app to the background (e.g., by running another app) for a short period of time, and then switches back the app. Android pauses the app when the switch happens, and resumes it after the app is switched back. In approximate execution mode, the disclosed subject matter calls the foreground activity's event handlers onPause and onResume to emulate this action. In faithful execution mode, the disclosed subject matter starts another app (currently Android's Settings app for configuring system-wide parameters), waits for one second, and then switches back. A reason for false positives is that developers can alter the event handlers called to handle lifecycle events.

StopStart:

This action is more involved than PauseResume. It occurs when a user switches an app to the background for a longer period of time, and then switches back. Since the time the app is in background is long, Android saves the app's state and destroys the app to save memory. Android later restores the app's state when the app is switched back. In approximate execution mode, the disclosed subject matter calls the following event handlers of the current activity: onPause, onSavelnstanceState, onStop, onRestart, onStart, and onResume. In faithful execution mode, the disclosed subject matter starts another app, waits for ten seconds, and switches back. A reason for false positives is that developers can alter the event handlers called to handle lifecycle events.

Relaunch:

This action occurs when a user introduces some configuration changes that cause the current activity to be destroyed and recreated. For instance, a user can rotate her device (causing the activity to be destroyed) and rotate it back (causing the activity to be recreated). In approximate execution mode, the disclosed subject matter calls Android's recreate event to destroy and recreate the activity. In faithful execution mode, the disclosed subject matter injects low-level events to rotate the device's orientation twice. A reason for false positives is that apps can register custom event handlers to handle relaunch-related events, so the activities are not actually destroyed and recreated.

All seven of actions in the first class run much faster in approximate mode than in faithful mode, so the disclosed subject matter runs them in approximate mode during exploration. The disclosed subject matter supports a second class of five actions for which invoking their handlers is as fast as sending low-level events. Thus, the disclosed subject matter injects low-level events for these actions in both approximate and faithful execution modes.

Click:

A user quickly taps a GUI widget. In either execution mode, the disclosed subject matter sends a pair of touch events, Down and Up, to the center of a widget.

KeyPress:

A user presses a key on the phone, such as the Back key or the Search key. The disclosed subject matter sends a pair of key events, Down and Up, with the corresponding key code to the app. This action sends only special keys because standard text input is handled by SetEditText.

MoveSeekBar:

A user changes the value of a seek bar widget. In either execution modes, the disclosed subject matter calculates the physical position on the widget that corresponds to the value the user is setting, and sends a pair of Down and Up touch events on that position to the widget.

Slide:

A user slides her finger on the screen. The disclosed subject matter first sends a touch event Down on the point where the slide starts. A series of Move touch events is sent at points along the slide path. An Up touch event is sent at the point where the slide stops. In this example, the disclosed subject matter supports two types of slides: horizontal and vertical.

Rotate:

A user changes the orientation of the device. The disclosed subject matter injects a low-level event to rotate the device's orientation.

The disclosed subject matter supports a third class of eight actions caused by external events in the execution environment of an app, such as the disconnection of a wireless network. The disclosed subject matter injects such events by sending emulated low-level events to an app instead of, for example, actually disconnecting from the network.

Intent:

An app can run an activity in response to a request from another app. Such requests are called intents in Android. The disclosed subject matter injects all intents that an app declares to handle, such as viewing data, searching for media files, and getting data from a database.

Network:

The disclosed subject matter injects network connectivity change events, such as the change from a wireless to the 3G network and from a connected to a disconnected network status.

Storage:

The disclosed subject matter injects storage related events, such as the insertion or removal of a Secure Digital (SD) memory card.

When the disclosed subject matter explores app executions for bugs, it runs the actions described above in approximate execution mode for speed. An exemplary algorithm to explore one execution of a mobile app for bugs is shown below:

explore_once( ) { // returns a bug trace

trace = { };
reset_init_state( );
while (app not exit and action limit not reached) {

action list = collect( );
action = choose(action list);
perform(action, APPROX);
trace.append(action);
if (failure found)

return trace;

}

}

The disclosed algorithm sets the initial state of the app and then repeatedly collects the actions that can be done, chooses one action, performs the action in approximate mode, and checks for bugs. If a failure such as an app crash occurs, the algorithm returns a trace of the actions that led to the failure.

To explore additional executions, the disclosed subject matter can run the algorithm repeatedly. The system can leverage Android's instrumentation framework to collect available actions by traversing the GUI hierarchy of the current activity. The disclosed subject matter can then choose one of the actions to inject. By configuring which actions to choose, the disclosed subject matter can implement different search heuristics such as depth-first search, breadth-first search, priority search, or a random walk. It can also perform each new action as soon as the previous action is complete, further improving performance.

The bug reports are not always indicative of true bugs because the effects of actions in approximate execution mode are not always reproduced by the same actions in faithful mode. Manually inspecting each bug report would be labor-intensive and error-prone, raising challenges for time and resource-constrained app developers. The disclosed subject matter can automatically classify bug reports for the developer using the algorithm shown below to diagnose one trace:

diagnose(trace) { // returns type of bug report

// procedure 1: tolerate environment problems
if (not reproduce(trace, APPROX))

return PRUNED_FP;

// procedure 2: auto-verify bugs
trace = slice(trace);
if (reproduce(trace, FAITHFUL)) {

testcase = to_monkeyrunner(trace);
if (MonkeyRunner reproduces the failure with

testcase)

return VERIFIED_BUG;

else return LIKELY_BUG;

}
// procedure 3: auto-prune false positives
for (action1 in trace) {

reset_init_state( );
// replay actions in approximate mode, except action1
for (action2 in trace) {

if (action2 != action1)

perform(action2, APPROX);

else

perform(action2, FAITHFUL);

if (replay diverges) break;

}
if (failure disappears)

return PRUNED_FP; // action1 is the culprit

}
return LIKELY_FP;

}

The above algorithm takes an action trace from a bug report, and classifies the report as one of four types: (1) verified bugs (real bugs reproducible on clean devices); (2) pruned false positives; (3) likely bugs; and (4) likely false positives. Type 1 and 2 need no further manual inspection to classify (for verified bugs, developers still have to pinpoint the code responsible for the bugs and correct it). The disclosed techniques can be more effective when more reports are categorized in these two types. Type 3 and type 4 bug reports can require some manual inspection. In such cases, the detailed action trace and categorization can help reduce manual inspection effort.

The disclosed subject matter can automatically diagnose a bug report. First, the system can filter bugs to prune false positives caused by Android, an OS emulator, or environment problems. Specifically, the system replays the trace in approximate execution mode to check whether the same failure occurs. If the failure disappears, then the report is most likely caused by problems in the environment, such as bugs in the Android emulator or temporary problems in remote servers. The disclosed subject matter prunes such reports as false positives.

Next, the system can automatically verify bugs. Specifically, it simplifies the trace using the action slicing technique described below, and replays the trace in faithful mode. If the same failure appears, then the trace almost always corresponds to a real bug. The disclosed subject matter then generates a MonkeyRunner test-case, and verifies the bug using a clean device. If failure is reproduced in this way, the report can be classified as a verified bug. The test-case can be sent directly to developers for reproducing and diagnosing the bug. If MonkeyRunner cannot reproduce the failure, then the error is potentially caused by the difference in how the disclosed subject matter and MonkeyRunner wait for an action to finish. The disclosed subject matter classifies the report as a likely bug, so developers can inspect the trace and modify the timing of the events in the MonkeyRunner test-case to verify the bug.

The disclosed subject matter can also automatically prunes false positives. At this point, the trace can be replayed in approximate mode, but not in faithful mode. It can pinpoint the action that causes this divergence, it can confirm that the report is a false positive. With reference to the label actionl, for each action in the trace, all other actions in the trace in approximate execution mode can be replayed except this action. If the failure disappears, the culprit of the divergence can be found and the report classified as a pruned false positive. Otherwise, it can be classified as a likely false positive for further inspection.

### Action Slicing

The disclosed subject matter also uses action slicing to remove unnecessary actions from a trace before determining whether the trace is a bug or false positive. By shortening the trace, action slicing also shortens the final test-case (if the report is a bug), in turn reducing the effort required by the developer to confirm and diagnosis the error. A shorter trace can also speed up replay.

Slicing techniques can shorten an instruction trace by removing instructions irrelevant to reaching a target instruction. However, certain techniques hinge on a clear specification of the dependencies between instructions, which is not necessarily available.

However, because the disclosed subject matter already provides a way to validate traces, it can embrace approximation in slicing as well. Given a trace, the disclosed subject matter can apply a slicing algorithm that computes a slice assuming minimal, approximate dependencies between actions. It then validates whether this slice can reproduce the failure. If so, it returns this slice immediately. Otherwise, it applies a slow algorithm to compute a more accurate slice.

An exemplary fast slicing algorithm to remove actions from a trace is shown below:

fast_slice(trace) {

slice = { last action of trace };
for (action in reverse(trace))

if (action in slice)

slice.add(get_approx_depend(action, trace));

return slice;

}
get_approx_depend(action, trace) {

for (action2 in trace) {

if (action is enabled by action2)

return action2;

if (action is always available

&& action2.state == action.state)

return action2;

}

}

The algorithm accepts a trace as input and returns a slice of the trace containing those actions necessary to reproduce the failure. The algorithm begins by putting the last action of the trace into the slice because the last action is usually necessary to cause the failure. It then iterates through the trace in reverse order, adding any action that the actions in the slice approximately depend on.

The key aspect of the slicing algorithm is the get_approx_depend function, used for computing approximate action dependencies. This method leverages an approximate notion of an activity's state. Specifically, this state includes each widget's type, position, and content and the parent-child relationship between the widgets, as well as the data the activity saves when it is switched to background. To obtain this data, the disclosed subject matter calls the activity's onPause, onSaveInstanceState and onResume handler. The state is approximate because the activity can hold additional data in other places such as files.

The get_approx_depend function considers only two types of dependencies. First, if an action becomes available at some point, the disclosed subject matter considers that action dependent on the action that “enables” that action. For example, suppose a Click action is performed on a button and the app then displays a new activity. The Click action can be said to enable all actions of the new activity and such actions are dependent on the Click action.

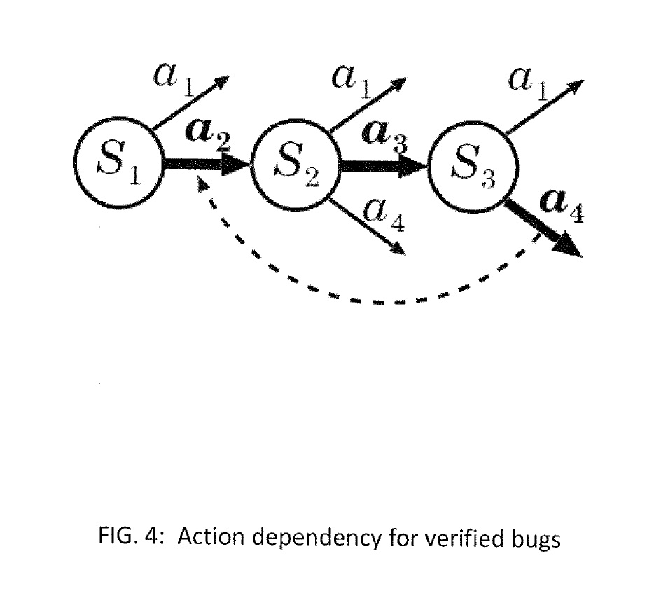

With reference to FIG. 4, Sᵢ represents app states, and aᵢ represents actions. Bold solid lines are the actions in the trace, thin solid lines show the other actions available at a given state, and dotted lines show the action dependency. In FIG. 4, a₄ depends on a₂ because a₂ enables a₄. Because action a₄ becomes available after action a₂ is performed, a₄ is considered to be dependent on a₂.

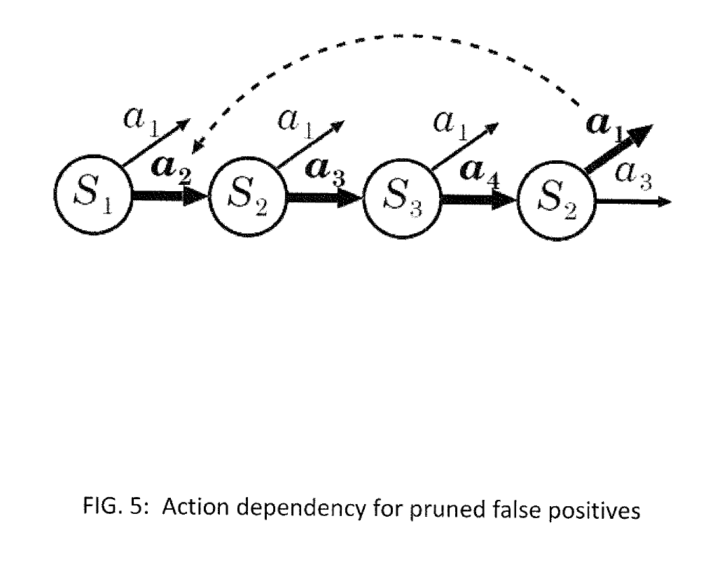

With reference to FIG. 5, if an action is always available (e.g., a user can always press the Menu key regardless of which activity is in foreground) and is performed in some state S₂, then it depends on the action that first creates the state S₂. In FIG. 5, a₁ depends on a₂ because a₁ is performed in S₂, and a₂ is the action that first leads to S₂. Suppose, for instance, a user performs a sequence of actions ending with action a₂, causing the app to enter state S₂ for the first time. She then performs more actions, causing the app to return to state S₂, and performs action a₁ “press the Menu key.” The get_approx_depend function will then conclude that action a₁ depends on action a₂. The intuition here is that the effect of an always available action usually depends on the current app state, and this state depends on the action that led the app to this state.

When the slice computed by fast slicing cannot reproduce the failure, the disclosed subject matter tries a slower slicing algorithm by removing cycles from the trace, where a cycle is a sequence of actions that starts and ends at the same state. For instance, and with reference to FIG. 7, the trace shown contains a cycle (S₂→S₃→S₂). If a sequence of actions does not change the app state, discarding those actions should not affect the reproducibility of the bug. If the slower algorithm also fails, the system falls back to the slowest approach. The disclosed subject matter then iterates through all actions in the trace, trying to remove them subset-by-subset.

Empirical results show that fast slicing works very well. In practice, it works for approximately 66% of traces. The slower version works for in approximately 15% of the cases. Only slightly more than 10% of cases needed the slowest version. Moreover, slicing reduced the mean trace length from 38.71 to 10.03, making diagnosis much easier.

### Implementation

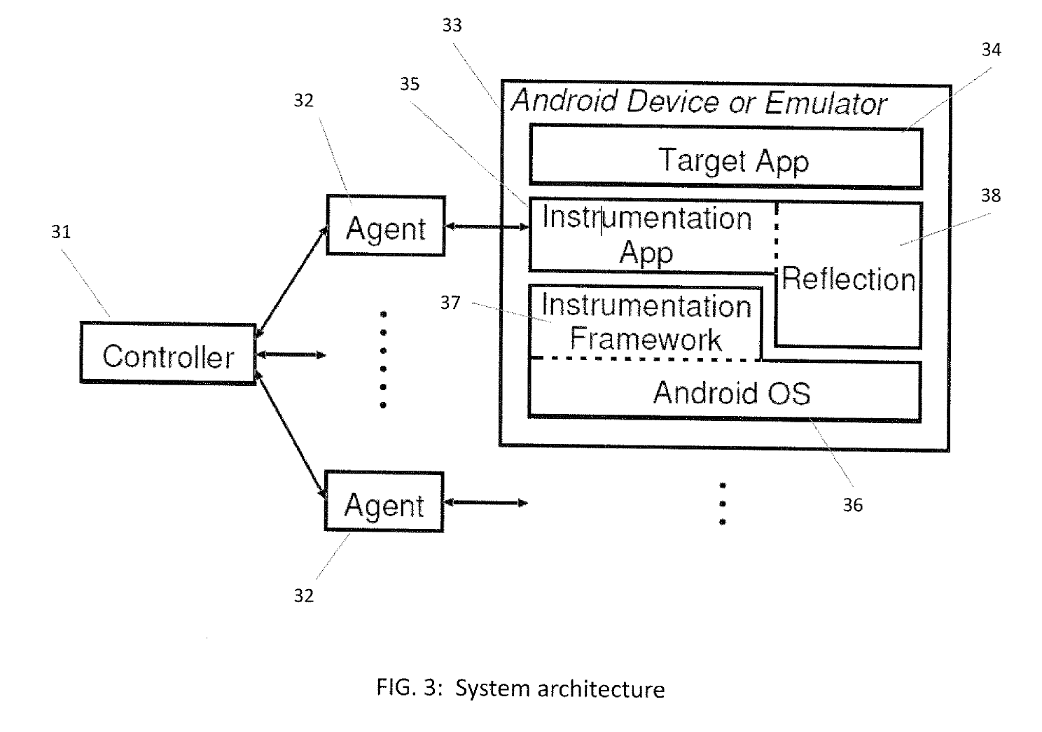

The disclosed subject matter can be run on a cluster of Android devices or emulators connected via a network such as the Internet. FIG. 3 shows an example system architecture. A controller 31 can monitor multiple agents 32 and, when one or more agents become idle, the controller 31 commands those agents to start checking sessions based on developer configurations. The agents 32 can run on the same machine as the controller 31 or across a cluster of machines, enabling the disclosed subject matter to scale well. Each agent 32 connects to a device or an emulator 33 via the Android Debug Bridge. The agent installs the target app 34 on the devices or emulators 33 for checking and also installs an instrumentation app 35 for collecting and performing actions. The agent then starts and connects to the instrumentation app 35, which in turn starts the target app 34. The agent then explores potential executions of the target app 34 by receiving the list of available actions from the instrumentation app 35 and sending commands to the instrumentation app to perform actions on the target app.

The agent 32 runs in a separate process outside of the emulator or the device 33 for robustness. It tolerates many types of failures including Android 36 system failures and emulator crashes. Furthermore, the agent 32 enables the system to store information between checking executions so that the disclosed subject matter does not repeat execution paths that were previously explored.

To test an app, an instrumentation module can monitor the app's state, collect available actions from the app, and perform actions on the app. The Android instrumentation framework 37 provides interfaces for monitoring events delivered to an app and injecting events into an app. The disclosed subject matter can include an instrumentation app 35, based on Android's instrumentation framework 37, which runs in the same process as the target app 34 to collect and perform actions. The disclosed subject matter can also leverage Java's reflection mechanism 38 to collect other information from the target app 34 that the Android instrumentation framework 37 does not provide. Specifically, the disclosed subject matter can use reflection to get the list of widgets belonging to an activity and to directly invoke an app's event handlers even if they are private or protected Java methods. The instrumentation app 35 can also enable support for app-specific checkers.

For security purposes, Android requires that the instrumentation app and the target app be signed by the same key. To work around this restriction, the disclosed subject matter unpacks the target app and then repacks and signs the app using its own key. Furthermore, in order to communicate with the instrumentation app through socket connections, the ApkTool can be used to add network permission to the target app.

The disclosed subject matter further provides techniques to speed up the testing process. The disclosed subject matter can pre-generate a repository of cleanly booted emulator snapshots, one per configuration (e.g., screen size and density). When checking an app, it can start from the specific snapshot instead of booting an emulator from scratch, which can take five minutes. Further, to check multiple executions of an app, the disclosed subject matter can reuse the same emulator instance instead of starting a new one. To reset the app's initial state, it can kill the app process and wipe its data.

The disclosed subject matter can explore potential executions of an app and can choose the next action to explore using different methods. For example, the disclosed subject matter can support the interactive, scripted, random, and systematic methods. With the interactive method, the disclosed subject matter shows the list of available actions to the developer and lets her decide which one to perform, so that the developer retains complete control of the exploration process. This method can be suitable for diagnosing bugs. With the scripted method, the developer writes scripts to select actions, and the disclosed subject matter runs these test scripts. This method can be suitable for regression and functional testing. With the random method, the disclosed subject matter randomly selects an action to perform. This method can be suitable for automatic testing. Finally, with the systematic method, the disclosed subject matter can enumerate through the available actions searching for bugs using several search heuristics, including breadth-first search, depth-first search, and developer-written heuristics. This method can be suitable for model checking.

The disclosed subject matter can perform actions on the target app as soon as the previous action is done. It detects when the app has completed an action using the Android instrumentation framework's waitForIdle function, which returns when the main thread—the thread for processing all GUI events—is idle. Two apps, Twitter and ESPN, can keep the main thread busy (e.g., during the login activity of Twitter), so the disclosed subject matter can revert to waiting for a certain length of time (i.e., three seconds). Apps can also run asynchronous tasks in background using Android's AsyncTask Java class, so even if an app's main thread is idle, the overall event processing can still be running. The disclosed subject can intercept asynchronous tasks and waits for them to finish, e.g., using reflection to replace the AsyncTask class with a custom implementation to monitor all background tasks and wait for them to finish.

Apps can require inputs to move from one activity to another. For instance, an app can ask for an e-mail address or user name before the user can proceed. The disclosed subject matter can generate proper inputs to improve coverage. Android allows developers to specify the type of data in a text box (e.g., e-mail address, integers, etc.), so that when a user starts typing, Android can display the keyboard customized for the type of text. The disclosed subject matter can automatically fill in many text boxes with text strings from a customizable, pre-generated database, which can include e-mail addresses, numbers, etc.

To further help developers test apps, the disclosed subject matter allows developers to specify custom input generation rules in the form of “widget-name:pattern-of-text-to-fill.” The most common use of this mechanism is to specify login credentials. Other than text boxes, developers can also specify rules to generate inputs for other actions, including the value set by SetNumberPicker, the item selected by ListSelect and the position set by MoveSeekBar. The disclosed subject matter can generate random inputs for these three actions. Note that it can leverage symbolic execution to generate inputs that exercise tricky code paths within apps. However, current mechanisms suffice to detect many bugs because most apps treat input text as a “black box,” simply storing and displaying the text without actually processing the text in a more complex way.

The disclosed subject matter can replay a trace to verify whether the trace can reproduce the corresponding failure. This replay is subject to non-determinism in the target app and environment. For simplicity, a best-effort replay technique can be used and the trace replayed multiple times in an effort to reproduce the failure.

One bug can manifest multiple times during exploration, causing many redundant bug reports. After collecting reports from all servers, redundant reports can be filtered based primarily on the type of the failure and the stack trace and keeps up to five reports per bug.

The disclosed subject matter can use ApkTool to unpack the target app for analysis, which processes AndroidManifest.xml to discover necessary information, including target app's identifier, startup activity, and library dependencies. It then uses this information to start the target app on configurations with the required libraries. Resource files can be analyzed to obtain symbolic names corresponding to each widget, enabling developers to refer to widgets by symbolic names in their testing scripts and input generation rules.

Two representative bugs discovered using the disclosed subject matter are described below. The first is a true bug and the second is an example of a false positive.

### Bug Example

The first example is an Android GUI framework bug that the disclosed subject matter automatically found and verified. The bug is found in Android's code for handling an app's request of a service. For instance, when an app attempts to send a text message and asks the user to choose a text message app, the app calls the Android createChooser method. Android then displays a dialog box containing a list of apps. When there is no app for sending text messages, the dialog is empty. If, at this moment, the user switches the app to the background, waits until Android saves the app's state and stops the app, and then switches the app back to the foreground, the app will crash as a result of dereferencing a null pointer.

One approach to finding mobile app bugs is to inject low-level events such as touch and key events using Android-provided tools such as Monkey and MonkeyRunner. This approach typically has no false positives because the injected events are identical to those that can be triggered by the user. However, this approach can be relatively slow because some low-level events take a long time to inject.

The systems and method disclosed herein provide an improvement. First, the disclosed subject matter can approximate the effects of the app stop and start by directly calling the app's lifecycle event handlers, which can be executed immediately, thus avoiding the long waits described above. The disclosed subject matter can also detect when an action is complete, and then immediately perform the next action. Further, the disclosed subject matter recognizes what actions are available in order to avoid performing redundant work. It detected the bug described above when checking the popular Craigslist app and a number of other apps. It also generated an event test-case that can reliably reproduce the problem on other devices, providing the same level of diagnosis help to developers as the Monkey system.

### False Positive Example

Another approach to test mobile apps is to drive app executions directly by calling the app's event handlers (e.g., by calling the handler of long-click without doing a real long-click) or mutating an app's data (e.g., by setting the contents of a text box directly). On its own, however, this approach suffers from false positives because the actions it injects are approximate. The potential for false positives means that developers sometimes manually inspect each bug report, a painstaking process. To better illustrate why this approach can yield false positives, a false positive that was encountered and automatically pruned will be described.

This false positive can be found in the MyCalendar app, which has a text box for users to input their birth month. The app customizes this text box by allowing users to select the name of a month using a number picker it displays, ensuring that the text box's content can only be the name of one of the twelve months. When the disclosed subject matter checked this app in approximate execution mode, it found an execution that led to an IndexOutOfBoundException. The disclosed subject matter found that this text box was marked as editable, so it set the text to “test,” a value real users can never set, in turn causing the crash. Tools that directly call event handlers or set app data will suffer from such false positives. Because of the significant possibility of false positives (approximately 25% of initial bug reports), developers must manually inspect these reports, a labor-intensive and error-prone process.

By coupling approximate and faithful execution modes, the disclosed subject matter automatically pruned this false positive. Specifically, for each bug report detected by performing actions in approximate mode, the disclosed subject matter validates that potential bug by performing the actions again in faithful mode. In this example, the disclosed subject matter attempted to set the text by issuing low-level touch and key events, but could not trigger the crash again because the app correctly validated the input avoiding the error. As a result, the disclosed subject matter automatically classified the error report as a false positive.

What is claimed is:

1. A system for detecting and diagnosing software bugs in mobile apps, comprising
automatically detecting a mobile app's GUI layout and associated event handlers;
an approximate execution mode configured to screen for potential bugs by invoking the mobile app's event handlers;
a failure detection module coupled to the mobile app and configured to detect app failure; and
a reporting module configured to return a trace of actions leading to failure of the mobile app.

2. The system of claim 1, wherein the reporting module is further configured to remove unnecessary and redundant actions in the trace of actions leading to the app failure.

3. The system of claim 2, wherein the approximate execution mode is further configured to invoke the mobile app's event handlers serially and without appreciable delay.

4. The system of claim 3, further comprising
a faithful execution mode configured to validate potential bugs by executing the trace of actions leading to the app failure; and
an automated false-positive pruning module configured to delete the trace of actions that does not lead to app failure in faithful execution mode.

5. The system of claim 4, wherein the reporting module is further configured to categorize bugs validated by the faithful execution mode.

6. The system of claim 5, wherein the reporting module is further configured to classify each reported bug as reproducible, a false positive, a likely bug, or a likely false positive.

7. A method of detecting and diagnosing software bugs in mobile apps by executing an app in an approximate execution mode comprising:
setting an initial state of the app;
collecting actions that can be performed on the app; and
repeatedly selecting an action, storing the selected action in an action trace, and performing the selected action by invoking the corresponding event handler.

8. The method of claim 7, further comprising detecting an app failure and returning the trace of the actions leading to the app failure.

9. The method of claim 8, further comprising removing unnecessary and redundant actions in the trace of actions leading to the app failure.

10. The method of claim 9, further comprising re-executing the trace of the actions leading to the app failure in a faithful execution mode.

11. The method of claim 9, further comprising invoking the mobile app's event handlers serially and without appreciable delay.

12. The method of claim 9, further comprising pruning false positives by deleting the trace of actions that do not lead to app failure in faithful execution mode.

13. The method of claim 12, further comprising categorizing validated bugs.

14. The method of claim 13, further comprising classifying each reported bug as reproducible, a false positive, a likely bug, or a likely false positive.

15. A scalable mobile app bug detection system comprising:
a. a controlling host; and
b. one or more testing hosts, controlled by the controlling host, each testing host executing the system of claim 1, wherein each of the one or more testing hosts provides bug reports to the controlling host.
